(19) United States
(12) Patent Application Publication
(10) Pub. No.: US 2023/0041567 A1
(43) Pub. Date: Feb. 9, 2023

(54) Calibration of a Solid-State Lidar Device

(71) Applicants: Radu Ciprian BILCU, Skalholtsgatan 9 (SE); Huawei Technologies Co.,Ltd., Shenzhen (CN)

(72) Inventor: Radu Ciprian Bilcu, Tampere (FI)

(21) Appl. No.: 17/758,820

(22) PCT Filed: Jan. 15, 2020
(86) PCT No.: PCT/EP2020/050932

§ 371 Date: Jul. 14, 2022

(51) Int. Cl. G01S 7/497; G01S 17/10; G01S 17/48; G01S 7/4865; G01S 7/4861; G01S 7/481

(52) U.S. Cl. CPC G01S 7/497; G01S 17/10; G01S 17/48; G01S 7/4865; G01S 7/4861; G01S 7/4816; G01S 7/4817

(57) ABSTRACT

A solid-state lidar device comprises a laser generator, an optical lens arrangement having a focal length and providing a rear focal plane, a solid-state sensing array positioned at the rear focal plane of the optical lens arrangement having a first sensor and a second sensor spaced from each other by a first sensor distance and at least one processor. The processor is configured to obtain a measured distance of the target from a pulsed time-of-flight measurement utilizing the laser generator and at least one of the first sensor and the second sensor of the solid-state sensing array and obtain at least one spatial coordinate for the target from the measured distance using a calibration parameter indicative of the ratio of the first sensor distance and the focal length.

### CROSS-REFERENCE TO RELATED APPLICATIONS

This application is a National Stage of International Application No. PCT/EP2020/050932, filed on Jan. 15, 2020, the disclosure of which is hereby incorporated by reference in its entirety.

### TECHNICAL FIELD

The disclosure relates to a solid-state lidar device and, in particular, to its calibration. Furthermore, the disclosure relates to methods for executing and calibrating, respectively of a solid-state lidar device and a corresponding computer program product.

### BACKGROUND

Three-dimensional imaging devices can be used to detect the spatial coordinates of objects in their field-of-view. For this purpose, both passive and active depth sensing equipments are presently in existence, the latter further including both mechanical scanners and solid-state imaging devices.

Regardless of the implementation, the imaging devices need to be calibrated in order to achieve high precision and accuracy levels. Devices using moving parts have typically more parameters in their models and consequently require a more complex calibration process. However, even devices with few or no moving parts typically require calibration efforts by means of a well-defined calibration environment.

### SUMMARY

This summary is provided to introduce a selection of concepts in a simplified form that are further described in the detailed description below. This summary is neither intended to identify key features or essential features of the claimed subject matter, nor is it intended to be used to limit the scope of the claimed subject matter.

It is an object to provide a solid-state lidar device and a method for calibrating a solid-state lidar device. The object may be solved using the features of the independent claims. Further implementation forms are provided in the dependent claims, the description and the figures. In particular, it is an objective to provide the device and the method with intrinsic calibration, allowing calibration to be performed without specifically arranged three-dimensional calibration environment.

According to a first aspect, a solid-state lidar device comprises a laser generator for generating a pulsed laser beam that may be directed on a target, an optical lens arrangement for collecting the laser beam reflected by the target, a solid-state sensing array and at least one processor. The optical lens arrangement has a focal length and provides a rear focal plane, whereas the solid-state sensing array is positioned at the rear focal plane of the optical lens arrangement for detecting the laser beam. The solid-state sensing array comprises at least a first sensor and a second sensor for detecting the reflected laser beam, wherein the first sensor and the second sensor are spaced from each other by a first sensor distance. The at least one processor is configured to obtain a measured distance of the target from a pulsed time-of-flight measurement utilizing the laser generator and at least one of the first sensor and the second sensor of the solid-state sensing array. The at least one processor is also configured to obtain at least one spatial coordinate for the target from the measured distance using a calibration parameter indicative of the ratio of the first sensor distance and the focal length. Using a calibration parameter indicative of the specific ratio allows simple and efficient calibration of the solid-state lidar device since there is no need to separately obtain component-specific calibration parameters for the sensors or the optical lens arrangement. This has also been found to enable a significant reduction in the complexity of the calibration environment required, as the calibration can then be performed without pre-determined three-dimensional calibration objects, for example whose size, shape and position is known.

In an implementation form of the first aspect, the first sensor and the second sensor are single-photon avalanche diodes (SPADs) arranged at a common substrate of the solid-state sensing device. This allows the first sensor and the second sensor to be accurately positioned, even with a large sensor density of the solid-state sensing array, thereby providing a high calibration accuracy.

In a further implementation form of the first aspect, the solid-state sensing array further comprises a third sensor for detecting the reflected laser beam so that the first sensor, the second sensor and the third sensor are arranged in a one-dimensional arrangement. The field-of-view of the solid-state sensing array can thereby be increased.

In a further implementation form of the first aspect, the solid-state sensing array further comprises a third sensor for detecting the reflected laser beam so that the second sensor and the third sensor define a second sensor distance equal to the first sensor distance. Thereby, using an equal sensor distance between different sensors may extend the simple and efficient calibration procedure above to different types of sensing arrays.

In a further implementation form of the first aspect, the at least one processor is configured to obtain the at least one spatial coordinate using an optimal value for the calibration parameter. The optimal value can be obtained by obtaining multiple measured distances to different spatial locations of the target, each measured distance corresponding to a different sensor of the solid-state sensing array and calculating the optimal value by fitting a fitting function to a point cloud function comprising provisional spatial coordinates for the different spatial locations of the target, wherein the provisional spatial coordinates are obtained from the multiple measured distances using a provisional value for the calibration parameter, so that the optimal value is the provisional value which optimizes the fitting. This allows optimization of the value for the calibration parameter in an expedient way. The optimal value can be obtained even from a single scan of a target. The position and size of the target are not necessary to be known, as long as the target has a basic shape for scanning that corresponds to the fitting function. This allows intrinsic calibration with the basic shape. In one further implementation form, the fitting function refers to a linear function representable as a straight line or a flat plane. This allows an efficient calibration with targets that are prevalent in built environments such as a flat wall.

In a further implementation form of the first aspect, the at least one spatial coordinate for the target is obtained from the measured distance by modifying the measured distance by at least one additional sensor-specific calibration parameter indicative of inaccuracy for the measured distance for at least one sensor of the solid-state sensing array. This allows efficiently accounting for any type of sensor-specific sources of inaccuracy such as measurement errors and/or delays.

According to a second aspect, a method comprises causing a solid-state lidar device according to the first aspect or any of its implementation forms to scan a target for obtaining an optimal value for the calibration parameter. This allows calibration of the solid-state lidar device by one or more scans of the device.

In a further implementation form of the second aspect, the target comprises a flat surface facing the laser generator, wherein the laser beam is reflected at the flat surface. This allows intrinsic calibration of the solid-state lidar device with the flat surface. It has been found that this also allows the accuracy of the calibration to be verified easily, as any deviation for the calibration parameter from its optimal value can be identified by a scan by the solid-state lidar device producing a curved shape when the target is a flat surface.

In a further implementation form of the second aspect, the scanning is performed with the solid-state sensing array positioned non-parallel with respect to the target. This has been found to increase robustness of calibration as it allows the calibration of the solid-state lidar device according to the first aspect or any of its implementation forms to provide a single, non-ambiguous optimal value for the calibration parameter instead of two or more different local optima.

According to a third aspect, a method for operating a solid-state lidar device is disclosed. The solid-state lidar comprises a laser generator for generating a pulsed laser beam that may be directed on a target, an optical lens arrangement for collecting the laser beam reflected by the target and a solid-state sensing array. The optical lens arrangement has a focal length and provides a rear focal plane, whereas the solid-state sensing array is positioned at the rear focal plane of the optical lens arrangement for detecting the laser beam, wherein the solid-state sensing array comprises at least two sensors, which are spaced equidistantly in at least one dimension, a first sensor distance apart from each other. The method comprises, for example by at least one processor configured for such a purpose, obtaining a measured distance of the target from a pulsed time-of-flight measurement utilizing the laser generator and a sensor of the solid-state sensing array and obtaining at least one spatial coordinate for the target from the measured distance using a calibration parameter indicative of the ratio of the first sensor distance and the focal length. Using a calibration parameter indicative of the specific ratio allows simple and efficient calibration of the solid-state lidar device since there is no need to separately obtain component-specific calibration parameters for the sensors or the optical lens arrangement. This has also been found to allow significant reduction in the complexity of the calibration environment required as the calibration can then be performed without pre-determined three-dimensional calibration objects, for example whose size, shape and position is known.

In a further implementation form of the third aspect, the at least two sensors are single-photon avalanche diodes (SPADs) arranged at a common substrate of the solid-state sensing array. This allows the first sensor and the second sensor to be accurately positioned, even with a large sensor density of the solid-state sensing array, thereby providing a high calibration accuracy.

In a further implementation form of the third aspect, the at least one spatial coordinate is obtained using an optimal value for the calibration parameter. The optimal value can be obtained by obtaining multiple measured distances to different spatial locations of the target, each measured distance corresponding to a different sensor of the solid-state sensing array, and calculating the optimal value by fitting a fitting function to a point cloud function comprising provisional spatial coordinates for the different spatial locations of the target, wherein the provisional spatial coordinates are obtained from the multiple measured distances using a provisional value for the calibration parameter, so that the optimal value is the provisional value which optimizes the fitting. This allows optimization of the value for the calibration parameter in an expedient way. The optimal value can be obtained even from a single scan of a target. The position and size of the target are not necessary to be known, as long as the target has a basic shape for scanning that corresponds to the fitting function. This allows intrinsic calibration with the basic shape. In one further implementation form, the fitting function refers to a linear function representable as a straight line or a flat plane. This allows an efficient calibration with targets that are prevalent in built environments such as a flat wall.

In a further implementation form of the third aspect, the at least one spatial coordinate for the target is obtained from the measured distance by modifying the measured distance by at least one additional sensor-specific calibration parameter indicative of inaccuracy for the measured distance for at least one sensor of the solid-state sensing array. This allows efficiently accounting for any type of sensor-specific sources of inaccuracy such as measurement errors and/or delays.

According to a fourth aspect, a computer program product comprising program code is configured to perform the method of the second or the third aspect or any of their implementation forms.

According to still a further aspect, the invention also relates to a computer readable medium, such as a non-transitory computer readable medium, and said mentioned computer program code, wherein said computer program code is included in the computer readable medium, and the computer medium comprises of one or more from the group: ROM (Read-Only Memory), PROM (Programmable ROM), EPROM (Erasable PROM), Flash memory, EEPROM (Electrically EPROM) and hard disk drive.

Many of the attendant features will be more readily appreciated as they become better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 illustrates a schematic representation of a solid-state lidar device according to an embodiment scanning a target;

FIG. 2 illustrates a schematic representation of mathematical principles for calibration of a solid-state lidar device according to an embodiment;

FIG. 3 illustrates a flow chart representation of a method for obtaining an optimal value for a calibration parameter according to an embodiment;

FIG. 4 illustrates two different point cloud functions obtained with two different values for the calibration parameter according to an embodiment; and

FIG. 5 illustrates a flow chart representation of a method for executing a solid-state lidar device according to a further embodiment.

Like references are used to designate like parts in the accompanying drawings.

### DETAILED DESCRIPTION OF ILLUSTRATIVE EMBODIMENTS

The detailed description provided below in connection with the appended drawings is intended as a description of the embodiments and is not intended to represent the only forms in which the embodiment may be constructed or utilized. However, the same or equivalent functions and structures may be accomplished by different embodiments.

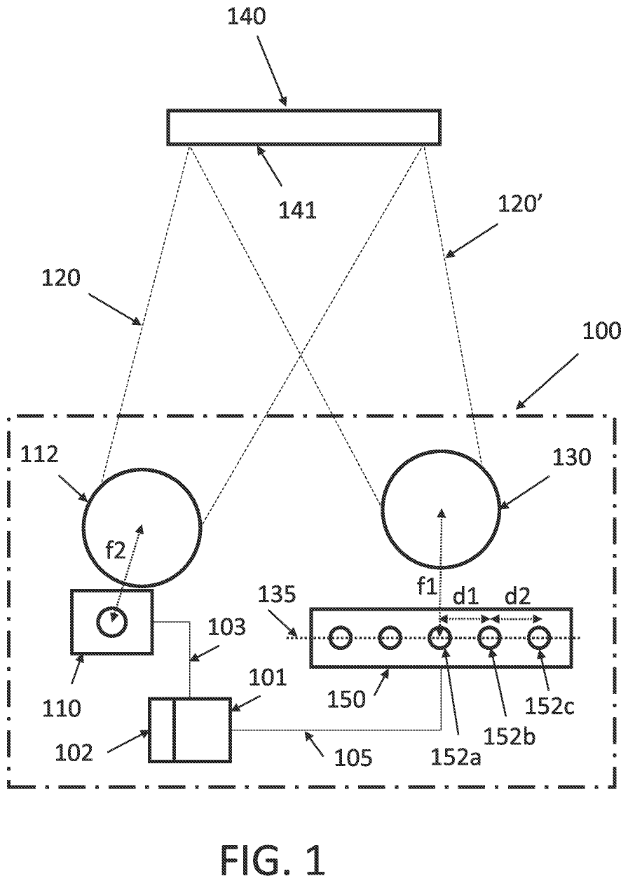

FIG. 1 illustrates a schematic representation of a solid-state lidar device 100 (herein also “the device”) according to an embodiment scanning a target 140. Herein, a “lidar device” may refer to a detection system which is configured to measure distance to the target 140 by illuminating the target 14o with a laser beam 12o and measuring the reflected laser 120′ beam with one or more sensors 152a-152c. Differences in laser beam return times can then be used to make digital representations of the target 14o in one, two or three spatial dimensions. Herein, a “solid-state lidar device” may refer to a lidar device 100, where a sensing array 15o is a solid-state sensing array 150, where sensors can be embedded at one or more chips such as silicon chips. The solid-state sensing array 150 may be configured for measuring distance statically so that it does not necessarily require any mechanically moving parts. As a result, the solid-state lidar device 100 as a whole may be configured for measuring distance statically so that it does not necessarily require any mechanically moving parts.

The device 100 comprises a laser generator 110. The laser generator can be configured to generate a pulsed laser beam 120 that may be directed on a target 140. The device 100 may also comprise a diffuser 112 for spreading out the laser beam 120 from the laser generator 110. The diffuser 112 may comprise a further lens arrangement (not depicted in FIG. 1) and may further comprise a focal length f2. The diffuser 112 may be coupled to the laser generator 110. In some embodiments, the distance between the diffuser 112 and the laser generator 110 may correspond to the focal length f2.

The device 100 comprises an optical lens arrangement 130, which can be configured to collect the laser beam 120′ reflected by the target 140. The optical lens arrangement 130 has a focal length f1 and thereby provides a rear focal plane 135. In some embodiments, the focal length f1 of the optical lens arrangement 130 may be the same as the focal length f2 of the diffuser 112. According to some further embodiments, however, the focal lengths f₁ and f2 may be different.

The device 100 comprises a solid-state sensing array 150 (herein also “the array”), which is positioned at the rear focal plane 135. The array 150 comprises at least two sensors, a first sensor 152a and a second sensor 152b, which may be configured to detect the reflected laser beam 120′ . However, the array 15o may comprise also three or more sensors, e.g. ten or more sensors, for this purpose, while some embodiments may comprise a very large number of sensors as far as the solid-state sensing array technology practicably allows. The array 15o may comprise a one-dimensional or a two-dimensional arrangement of sensors. Any two sensors in a one-dimensional arrangement, for example the first sensor 152a and the second sensor 152b, may be spaced from each other by a first sensor distance d1. When the array 150 comprises a third sensor 152C for detecting the reflected laser beam 120′ , the second sensor 152b and the third sensor 152C may define a second sensor distance d2, which can be equal to the first sensor distance d1. This way, the first sensor 152a, the second sensor 152b and the third sensor 152c may be positioned equidistantly along a line, which can be utilized to considerably simplify the calibration of the device 100.

When the one-dimensional arrangement comprises three or more sensors 152a-152c, the sensors of the arrangement can thereby be spaced equidistantly with a sensor-to-sensor distance for any two adjacent sensors corresponding to the first sensor distance d1. The sensor-to-sensor distance may thereby be constant for any two adjacent sensors along a dimension. When the array 15o comprises a two-dimensional arrangement of sensors, the arrangement may have a first sensor-to-sensor distance in the first dimension of the two-dimensional arrangement and a second sensor-to-sensor distance in the second dimension of the two-dimensional arrangement. The first sensor-to-sensor distance may be equal to the second sensor-to-distance, which may be used to reduce the number of calibration parameters required in comparison to a two-dimensional arrangement where the first sensor-to-sensor distance is different from the second sensor-to-distance.

The array 15o may comprise a substrate arranged to support one or more sensors of the array 15o, such as the first sensor 152a, the second sensor 152b and the third sensor 152c. In some embodiments, one or more sensors of the array 150, for example the first sensor 152a and/or the second sensor 152b, optionally also the third sensor 152 or even any of the plurality of sensors 152a-152c, are arranged on a common substrate of the array 150. In some embodiments, one or more sensors of the array 150, for example the first sensor 152a and/or the second sensor 152b, optionally also the third sensor 152, can be single photon avalanche diodes (SPAD), which are particularly suitable for arrangement on a common substrate, thereby allowing the sensors to be positioned accurately for one- or two-dimensional arrangements. Using a common substrate, for example for multiple SPAD sensors, allows a high degree of accuracy for constant sensor-to-sensor distance.

The device 100 also comprises at least one processor 101 (herein also “the processor”). The processor 101 is configured to obtain a measured distance of the target 140 of the target from a pulsed time-of-flight measurement utilizing the laser generator 110 and at least one sensor of the array 15o, such as the first sensor 152a or the second sensor 152b. For operating the laser generator 110, the processor 101 may be coupled to the laser generator 110 through a first link 103 of the device 100, which link may comprise a wired and/or a wireless data transfer connection. For obtaining the measured distance, the processor 101 may be coupled to the sensing array 15o through a second link 105 of the device 100, which link may comprise a wired and/or a wireless data transfer connection.

Herein, a “pulsed time-of-flight measurement” may refer to a measurement, where a time-of-flight for a pulse of the laser beam (12o, 120′ ) is measured and a travel distance for the pulse is determined based on the time-of-flight. Herein, a “time-of-flight” may refer to a time from generating the pulse at the laser generator 110 to capturing the pulse at the array 150. The travel distance may be determined by the processor 101. Herein, a “measured distance of the target 14o” may refer to a distance measured by a sensor 152a-152c of the array 150 capturing the pulse, wherein the distance represents the distance between the sensor and the target 140. The measured distance may be obtained from the travel distance or from the time-of-flight using any methods known to a person skilled in time-of-flight measurements. The measured distance may also be determined by the processor 101.

The processor 101 is also configured to obtain at least one spatial coordinate for the target 14o from the measured distance. Herein, a “spatial coordinate” may refer to a data point representative of the spatial position of a single spatial location of the target 140. The at least one spatial coordinate may comprise two- or three-dimensional coordinates for a single spatial location of the target 14o. The at least one spatial coordinates may be represented in any coordinate system, for example in the Cartesian coordinate system.

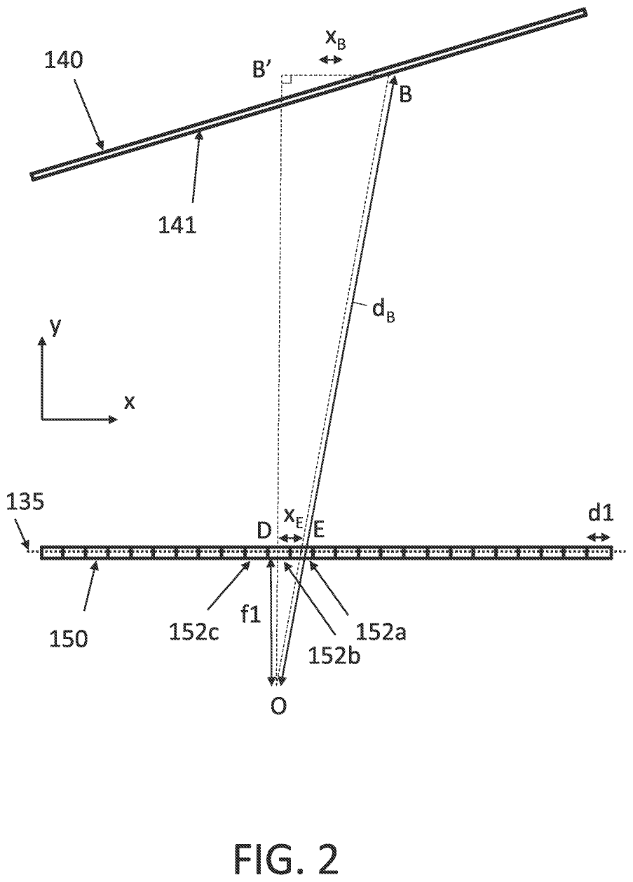

The at least one spatial coordinate is obtained using a calibration parameter indicative of the ratio of the first sensor distance d1 and the focal length f1 of the optical lens arrangement 130. An example is provided with reference to FIG. 2.

The processor 101 may comprise, for example, one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The device 100 may further comprise at least one memory 102 (herein also “the memory”). The processor 101 may be configured to perform the any of the processes described herein for the processor 101 according to a program code comprised in the memory 102.

The memory 102 may be configured to store, for example, computer programs and the like. The memory 102 may include one or more volatile memory devices, one or more non-volatile memory devices, and/or a combination of one or more volatile memory devices and non-volatile memory devices. For example, the memory 102 may be embodied as magnetic storage devices (such as hard disk drives, floppy disks, magnetic tapes, etc.), optical magnetic storage devices, and semi-conductor memories (such as mask ROM, PROM (programmable ROM), EPROM (erasable PROM), flash ROM, RAM (random access memory), etc.).

The device 100 may further comprise a transceiver. The transceiver may be configured to, for example, transmit and/or receive data using, for example, a 3G, 4G, 5G, LTE, or WiFi connection.

The device 100 may also comprise other component and/or parts not illustrated in the embodiment of FIG. 1.

Functionality described herein may be implemented via the various components of the device 100. For example, the memory 102 may comprise program code for performing any functionality disclosed herein or causing any functionality disclosed herein to be performed, and the processor 101 may be configured to perform the functionality, or cause the functionality to be performed, according to the program code comprised in the memory 102.

When the device 100 is configured to implement some functionality, some component and/or components of the device 100, such as the at least one processor 101 and/or the memory 102, may be configured to implement this functionality. Furthermore, when the at least one processor 101 is configured to implement some functionality, this functionality may be implemented using program code comprised, for example, in the memory 102. For example, if the device 100 is configured to perform an operation, the at least one memory 102 and the computer program code can be configured to, with the at least one processor 101, cause the device 100 to perform that operation.

FIG. 2 illustrates a schematic representation of mathematical principles for calibration of a solid-state lidar device according to an embodiment. The principles are illustrated for a target 140 comprising a flat surface 141 but may also be applicable for targets having other surface shapes as well, for example a curved or a jagged surface.

As an example for what parameters need to be calibrated for the device 100, the solid-state sensing array 150 is schematically shown with respect to the target 140. Importantly, this schematic visualization involves a mathematical transformation of the geometry of the device 100 with respect to the target 140, allowing the effect of the optical lens arrangement 130 to be visualized by positioning the array 150 between an origin O of a coordinate system and the target 140 so that a perpendicular distance from the array 150 to the origin O corresponds to the focal length f1 of the optical lens arrangement. This mathematical representation corresponds to the physical arrangement, where the array 150 is positioned at the rear focal plane 135 of the optical lens arrangement 130. Herein, the coordinate system may be a Cartesian coordinate system with an x-axis parallel to the array 150 and y-axis perpendicular to the array 150, as indicated in the figure. Herein, the origin O of the coordinate system may refer to the optical centre of the optical lens arrangement 130.

The array 150 comprises a one-dimensional arrangement of sensors 152a-152c, comprising at least a first sensor 152a and a second sensor 152b but optionally also a third sensor 152C or even more sensors. In the visualization, each rectangle of the array 150 may correspond to a sensor so the number of sensors can be large. The first sensor 152a and the second sensor 152b are spaced from each other by a first sensor distance d1. The sensors of the one-dimensional arrangement may be spaced equidistantly with sensor-to-sensor distance equal to the first distance d₁. The example is applicable also when the array 150 comprises a two-dimensional arrangement of sensors, for example when the two dimensional arrangement is in the plane parallel to the x-axis and perpendicular to the y-axis.

The first sensor 152a may be configured to obtain a measured distance d_{B} to the target 140. Due to the mathematical transformation mentioned above, the measured distance d_{B}actually corresponds to the length of the line OB visualized extending from the origin O to a spatial location B of the target 140, whereas in an actual physical implementation of the device 100 the same measured distance d_{B} may correspond to the actual physical distance between the first sensor 152a and the spatial location B of the target 14o. A right-angled triangle OB′B can be defined with the right angle corresponding to a point B′ and the line OB′ being parallel with the y-axis of the coordinate system. If the surface of the target 140 was parallel to the array 150, point B′ would, for a target having a flat surface 141, be located at the surface of the target 140. As illustrated, the surface of the target 140 may be non-parallel to the array 150, in which case point B′ does not necessarily have any direct physical significance with respect to the target 140. However, in both cases it provides a reference point as the x-coordinate for point B is x_{B}. A smaller right-handed triangle ODE is formed with points D and E located at the intersections of the array 150 with the lines OB′ and OB, respectively. The second sensor 152b is positioned at point D, whereas the first sensor 152a is positioned at point E, so that the x-coordinate xE for the first sensor 152a is equal to the first sensor distance d₁.

As mathematical identities

$$\frac{O D}{{OB}^{′}} = \frac{{x}_{E}}{{x}_{B}}$$

$$and$$

$${x}_{B}^{2} = {OB}^{2} - {OB}^{′2} ,$$

when the length of any line is denoted by a two-letter combination of its end points, such as OB or OB′. Combining the two equation yields an y-coordinate for the spatial location B of the target 140:

$${OB}^{′} = {y}_{B} = \frac{O {B}^{2}}{\sqrt{1 + {( \frac{{x}_{E}}{O D} )}^{2}}} .$$

Here, OD=f₁ and OB=d_{B}. In the illustrated example, x_{E}is equal to d1. In addition, with constant sensor-to-sensor distance, which may be equal to d₁, a similar equation holds when point B at a different spatial location of the target 140 so that the line OB intersects a different sensor. When an index i_{E} for this different sensor is counted from the origin O, starting from the first adjacent sensor (in the illustration the first sensor 152a) having an index i_{E}=1 and the index increasing by one for each adjacent sensor when moving further away from the origin O. Consequently, x_{E}=i_{E} d₁0. For negative coordinates, the index may be negative, for example i_{E}=−1, for the third sensor 152c as illustrated in FIG. 2.

When a measured distance d_{B} is obtained utilizing a sensor having an index i_{E}, the y-coordinate for the spatial location of the target 140 can be obtained as

$${y}_{B} = \frac{{d}_{B}}{\sqrt{1 + {{i}_{E}^{2} ( \frac{d 1}{f 1} )}^{2}}} .$$

Similarly, from the previous equations the x-coordinate for the spatial location of the target 140 can be obtained as

$${x}_{B} = {i}_{E} \frac{d 1}{f 1} {y}_{B} .$$

The general principle illustrated here is applicable for the device as disclosed above. The device 100 can therefore be configured to determine spatial coordinates for the target 140, such as an x-coordinate x_{B} and an y-coordinate y_{B} for a spatial location of the target 140, from a measured distance dB, for example by the processor 101. For this, it is enough to use the information about which sensor was utilized for obtaining the measured distance dB, as may be indicated by an index iE of the sensor, together with a single parameter:

$$α = \frac{d 1}{f 1} .$$

As an example, coordinates for a spatial location of a target 140 can be obtained from a measured distance using parameter α as:

$${x}_{B} = {i}_{E} α {y}_{B} , {y}_{B} = \frac{{d}_{B}}{\sqrt{1 + {i}_{E}^{2} {α}^{2}}} . \qquad ( 1 )$$

This parameter α may consequently be used as a calibration parameter so that the device may be configured to receive a value for the calibration parameter, for example through a self-calibration procedure or even through a manual input, and use that value for determining any coordinates for a target 140 from distance measurements by the solid-state sensing array 150. Consequently, there is no need to receive separate values for the first sensor distance d₁ or the focal length f₁ of the optical lens arrangement 130. Moreover, there is no need to use separate sensor-specific calibration values for the sensor angles, i.e. a separate calibration value for the angle for each of the sensors of the array 150.

In an embodiment, the measured distance d_{B} may be modified by a sensor-specific calibration parameter indicative of inaccuracy for the measured distance d_{B}. The additional sensor-specific calibration parameter may be used to modify the measured distance d_{B} by any appropriate mathematical relation, for example, by an addition, subtraction, multiplication or division. As an example, the measured distance d_{B} for any or all sensors may be modified by an equation such as

d_{B}(i_{E})=d_{B}(i_{E})+δ(i_{E}),

meaning that for any sensor having index i_{E}, the measured distance d_{B}(i_{E}) obtained utilizing that sensor is modified by a sensor-specific calibration parameter δ(_{E}). The sensor-specific calibration parameters for two or more sensors may still have equal values. The sensor-specific calibration parameters may be used to allow compensating for delay in the electronics circuitry of the device 100, which may be due to the placement of the laser generator 110 and/or its optics relative to the solid-state sensing array 150. It may also be used to allow compensating for noise and/or imperfections in pulse detection for the laser beam 120′.

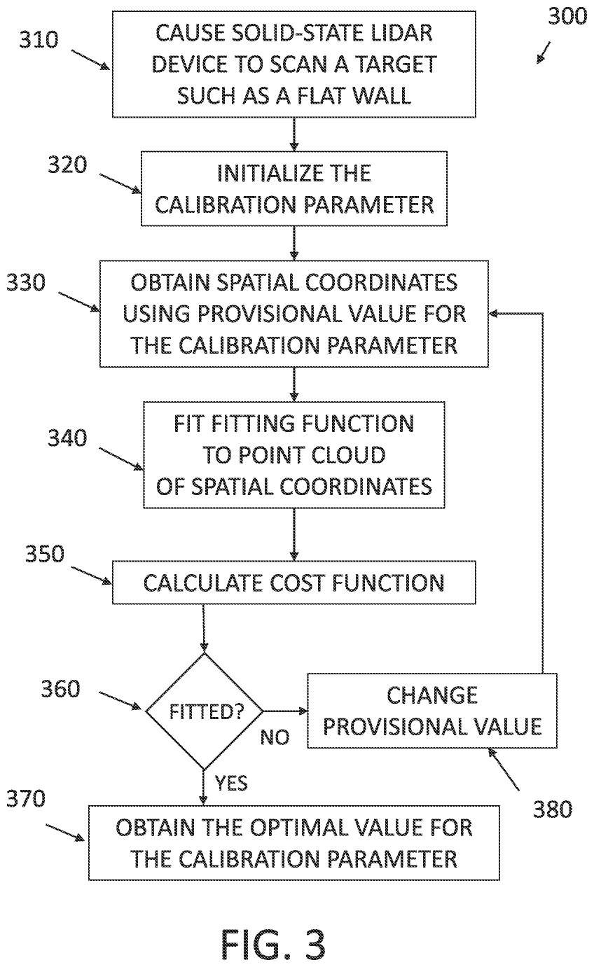

FIG. 3 illustrates a flow chart representation of a method 300 for obtaining an optimal value for a calibration parameter according to an embodiment. The method 300 can be used for calibrating a solid-state lidar device 100, which can be configured to obtain a spatial coordinate from a measured distance using a calibration parameter indicative of the ratio of a first sensor distance d₁ and a focal length f₁, for example the device 100 according to any of the examples presented herein.

The method comprises causing 310 a solid-state lidar device 100 to scan a target 140 for obtaining an optimal value for the calibration parameter. Herein, the “optimal value” may refer to a value which optimizes the fitting of a fitting function 430, 430′ to a point cloud function 420 comprising provisional spatial coordinates for different spatial locations of the target 140. The device 100 may be configured to use one or more fitting functions 430, 430′, such as linear function representable as a straight line or a flat plane. An effect of using a linear function is that a simplified calibration can then be performed by scanning a target 140 comprising a flat surface 141 facing the laser generator 110 of the device 100 so that the laser beam 120 from the laser generator 110 is reflected at the flat surface for capture at the solid-state sensing array 150 of the device 100. This way, no detailed knowledge of the shape and/or the position of the target 140 is required nor is the target required to have any specific size, shape or position other than the simple planar interface to be scanned at any distance. If the device is configured to use more than one fitting function 430, 430′, it may also be configured to allow an user to select the fitting function 430, 430′ to be used for calibration.

Herein, a “point cloud function” may refer to a function corresponding to a representation of a target 140. The point-cloud function 410, 420 comprises spatial coordinates for different spatial locations of the target 140. It may be obtained from a scan of a solid-state lidar device 100. Depending on whether the device 100 is correctly or incorrectly calibrated, the point cloud function 410, 420 may visually resemble the target 140. The point-cloud function 410, 420 may represent, for example, a two- or three-dimensional point-cloud of spatial coordinates.

The solid-state lidar device 100 may be configured to perform any combination of the steps hereafter for obtaining an optimal value for the calibration parameter. The calibration parameter may be initialized 320 to use a provisional value for the calibration parameter. The solid-state lidar device 100 may be configured to provide the provisional value automatically. Also, any constant value for the calibration parameter may be used. Provisional spatial coordinates for the target 140 may be obtained 33o based on the scan, for example from equation (1), using the provisional value for the calibration parameter α.

A point-cloud function 410, 420 may be formed comprising the provisional spatial coordinates for the target. The point-cloud function 410, 420 may comprise spatial coordinates for multiple spatial locations of the target 140. A fitting function 430, 430′, for example the linear function as described above, may then be fitted 340 to the point-cloud function. For this purpose, any applicable fitting methods known to a person skilled in the art of numerical optimization may be used, for example least squares fitting. A cost function may be calculated to determine how much the point-cloud function 410,420 deviates from the fitting function 430, 430′. This may be done when the parameters of the fitting function 430, 430′, such as the slope and intercept of a linear function, have been optimized by fitting to determine the final deviation. The use of a cost function can be used to ensure that, at convergence, fitted points are situated on a straight line, even for three-dimensional fitting.

The optimization may be performed iteratively. For this purpose the optimization may involve determining whether the fitting has been completed 360, for example due to the result having converged to the optimal value or the fitting process having reached a situation from which the optimal value cannot be reached. For this, one or more threshold criteria may be used. For example, determining whether the fitting has been completed 360 may comprise comparing the deviation between the fitting function 430, 430′ and the point-cloud function 410, 420. If the deviation is smaller than a threshold value, the provisional value for the calibration parameter used to obtain the point-cloud function 410, 420 may be used 370 as the optimal value for the calibration parameter. If the deviation is larger, the provisional value may be changed 380 to obtain new provisional spatial coordinates and new point-cloud function 410, 420. As another example of a stopping condition for the iteration, a no-improvement condition for stopping the iteration may be used. For example, the iteration may be stopped if the improvement for the deviation between two iterations is smaller than a threshold value for improvement. For example the Levenberg-Marquardt algorithm may be used for optimization of the calibration parameter.

The optimal value for the calibration parameter may be obtained 380, for example, as the provisional value of the calibration parameter when the fitting has been completed. For determining the optimal value, no pre-known distances or sizes for the scanning geometry are necessary. This allows for providing scene-agnostic calibration. Moreover, this may be used to improve the calibration precision since any measurement errors or limited measurement precision for such pre-known sizes or distances can be avoided altogether. The calibration may utilize a single scan or multiple scans, for example from different distances and/or orientations of the device 100 with respect to the target 140. Even then, there is no requirement to know or utilize the actual distances and orientations.

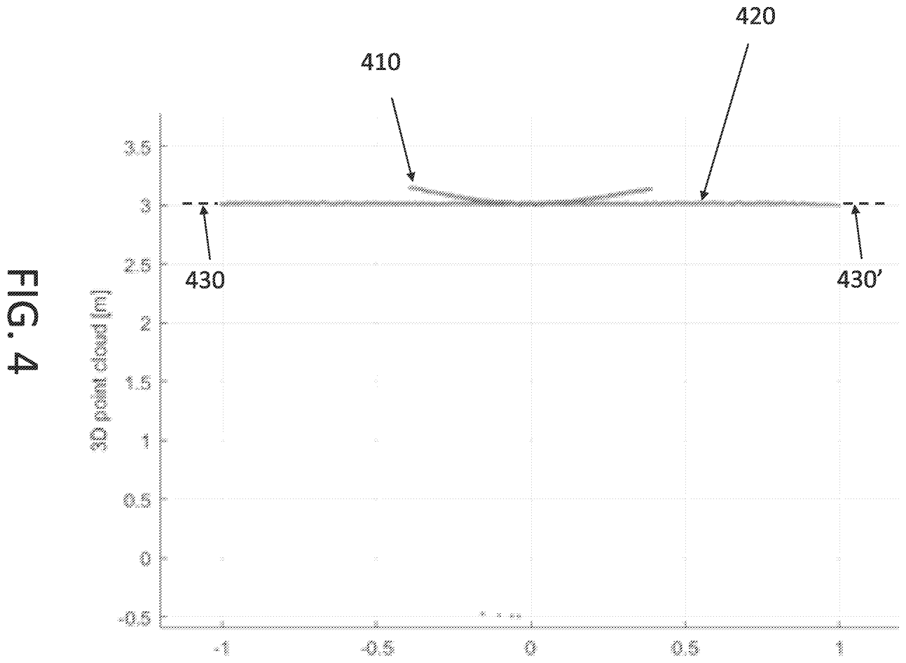

Choosing the optimal value for the calibration parameter may be used to provide a correct point-cloud function 420, the correctness of which may also be easily verified from a scan with a calibrated device 100, as shown with reference to FIG. 4. The robustness of calibration may be further improved by performing the calibration with a condition that any provisional and/or optimal value of the calibration parameter is larger than zero. Such a constraint may be included in the optimization algorithm for calibration, or for obtaining the optimal value for the calibration parameter. Alternatively or additionally, the robustness of calibration may be improved by performing the scanning for calibration by scanning a target 140 with a flat surface 141 facing the laser generator 110, wherein the laser beam 120 is reflected at the flat surface 141, when the solid-state sensing array 150 is positioned non-parallel with respect to the flat surface 141 of the target 140 for the scanning. This has been found to provide a unique solution for the optimal value of the calibration parameter, thereby allowing the calibration to be performed reliably with a single scan.

When one or more additional sensor-specific calibration parameters are used, the calibration may be performed in a similar manner as described above. For example, the same algorithm and/or the same cost function may be used. To improve robustness of calibration, it has been found that a fixed value, such as zero, may be assigned to one of the additional sensor-specific parameters, for example to the central sensor of the array 150.

FIG. 4 illustrates two different point cloud functions 410, 420 obtained with two different values for the calibration parameter according to an embodiment. The point-cloud functions 410, 420 have been obtained from a scan of a flat wall with a solid-state lidar device 100 as described herein. The horizontal axis represents a first spatial dimension, such as the x-dimension, whereas the vertical axis represents a second spatial dimension, such as the y-dimension. The first point-cloud function 410 has been obtained with an incorrectly calibrated device 100. Correspondingly, the value of the calibration parameter is essentially different from the optimal value that optimizes fitting with a linear function 430, 430′ (in the illustration, the linear fitting function 430, 430′ corresponds to a straight line between the first end 430 and the second end 430′). In contrast, the second point-cloud function 420 has been obtained with a correctly calibrated device 100. The value of the calibration parameter in this latter case is the optimal value that optimizes fitting with a linear function. The use of a non-optimal value for the calibration parameter can be immediately observed from a scan made by the device 100 since the scan from a flat wall provides a curved image, as represented by the first point-cloud function 410.

The solid-state lidar device 100, as disclosed in any of the examples herein, can thus be configured to obtain a spatial coordinate for a target 140 from a measured distance using parameter α as a calibration parameter, wherein the calibration parameter may be defined as the ratio of the first sensor distance d₁ and the focal length f₁. When such a device 100 is used, a calibration may be performed to determine an optimal value for the calibration parameter. The device 100 may be configured to perform the calibration when prompted. Consequently, the calibration can be performed quickly, on-demand if necessary, and also by an inexperienced user.

The device 100 may be configured to obtain the optimal value for the calibration parameter by obtaining multiple measured distances to different spatial locations of the target 140. Since different sensors of the array 15o can provide different measured distances, a single scan with the device 100, where multiple sensors are utilized to provide one measured distance corresponding to each sensor, may be enough for calibration of the device 100.

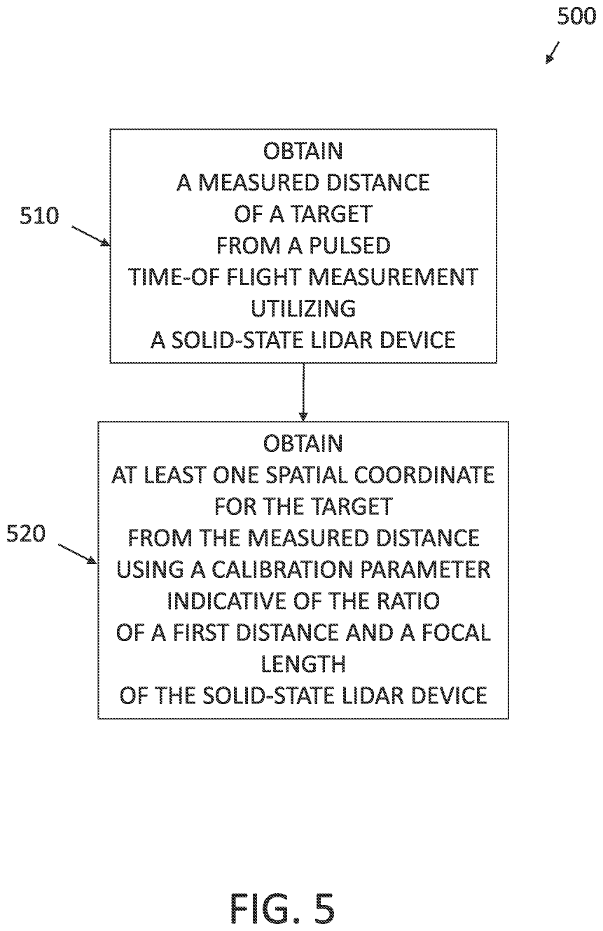

FIG. 5 illustrates a flow chart representation of a method 500 for executing a solid-state lidar device according to a further embodiment. The method 500 can be used for calibrating the solid-state lidar device 100 and/or for providing a scan with the solid-state lidar device 100. The device 100 may be a device according to any of the examples presented herein. The method 500 comprises obtaining 510 a measured distance of a target 140 from a pulsed time-of-flight measurement utilizing a solid-state lidar device 100, in particular a laser generator 110 and a sensor 152a-152c of a solid-state sensing array 150 thereof. The method further comprises obtaining 520 at least one spatial coordinate for the target 140 from the measured distance using a calibration parameter, which can be the calibration parameter according to any of the examples disclosed herein. According to some embodiments, the method 500 according to FIG. 5 may be combined with the method 300 according to FIG. 3, or may be combined with at least some features extracted from the method 300 of FIG. 3.

Although some of the subject matter has been described in language specific to structural features and/or acts, it is to be understood that the subject matter defined in the appended claims is not necessarily limited to the specific features or acts described above. Rather, the specific features and acts described above are disclosed as embodiments of implementing the claims and other equivalent features and acts are intended to be within the scope of the claims.

The functionality described herein can be performed, at least in part, by one or more computer program product components such as software components. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items. The term ‘and/or’ may be used to indicate that one or more of the cases it connects may occur. Both, or more, connected cases may occur, or only either one of the connected cases may occur.

The operations of the methods described herein may be carried out in any suitable order, or simultaneously where appropriate. Additionally, individual blocks may be deleted from any of the methods without departing from the objective and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, embodiments and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1.-16. (canceled)

17. A solid-state lidar device, comprising:
a laser generator configured to generate a pulsed laser beam that is directed on a target;
an optical lens arrangement configured to collect the laser beam after it is reflected by the target to form a reflected laser beam, the optical lens arrangement having a focal length and providing a rear focal plane;
a solid-state sensing array positioned at the rear focal plane of the optical lens arrangement, the solid-state sensing array comprising at least a first sensor and a second sensor configured to detect the reflected laser beam, wherein the first sensor and the second sensor are spaced from each other by a first sensor distance; and
at least one processor configured to:
obtain a measured distance of the target from a pulsed time-of-flight measurement utilizing the laser generator and at least one of the first sensor or the second sensor of the solid-state sensing array; and
obtain at least one spatial coordinate for the target from the measured distance using a calibration parameter indicative of a ratio of the first sensor distance and the focal length.

18. The device according to claim 17, wherein the first sensor and the second sensor are single-photon avalanche diodes (SPADs) arranged on a common substrate of the solid-state sensing array.

19. The device according to claim 18, wherein the solid-state sensing array further comprises a third sensor configured to detect the reflected laser beam, and wherein the first sensor, the second sensor and the third sensor are arranged in a one-dimensional arrangement.

20. The device according to claim 17, wherein the solid-state sensing array further comprises a third sensor configured to detect the reflected laser beam, and wherein the first sensor, the second sensor and the third sensor are arranged in a one-dimensional arrangement.

21. The device according to claim 20, wherein the second sensor and the third sensor define a second sensor distance that is equal to the first sensor distance.

22. The device according to claim 17, wherein the solid-state sensing array further comprises a third sensor configured to detect the reflected laser beam, and wherein the second sensor and the third sensor define a second sensor distance that is equal to the first sensor distance.

23. The device according to claim 22, wherein the at least one processor is configured to obtain the at least one spatial coordinate using an optimal value for the calibration parameter, the optimal value being obtained by:
obtaining multiple measured distances to different spatial locations of the target, each measured distance of the multiple measured distances corresponding to a different sensor of the solid-state sensing array; and
calculating the optimal value by fitting a fitting function to a point cloud function comprising provisional spatial coordinates for the different spatial locations of the target, wherein the provisional spatial coordinates are obtained from the multiple measured distances using a provisional value for the calibration parameter, and the optimal value is the provisional value which optimizes the fitting.

24. The device according to claim 23, wherein the fitting function is a linear function representable as a straight line or a flat plane.

25. The device according to claim 17, wherein the at least one processor is configured to obtain the at least one spatial coordinate using an optimal value for the calibration parameter, the optimal value being obtained by:
obtaining multiple measured distances to different spatial locations of the target, each measured distance of the multiple measured distances corresponding to a different sensor of the solid-state sensing array; and
calculating the optimal value by fitting a fitting function to a point cloud function comprising provisional spatial coordinates for the different spatial locations of the target, wherein the provisional spatial coordinates are obtained from the multiple measured distances using a provisional value for the calibration parameter, and the optimal value is the provisional value which optimizes the fitting.

26. The device according to claim 25, wherein the fitting function is a linear function representable as a straight line or a flat plane.

27. The device according to claim 17, wherein the at least one spatial coordinate for the target is obtained from the measured distance by modifying the measured distance by at least one additional sensor-specific calibration parameter indicative of inaccuracy for the measured distance for at least one sensor of the solid-state sensing array.

28. A method comprising:
causing a solid-state lidar device to scan a target to obtain an optimal value for a calibration parameter, the solid-state lidar device comprising:
a laser generator configured to generate a pulsed laser beam that is directed on a target;
an optical lens arrangement configured to collect the laser beam after it is reflected by the target to form a reflected laser beam, the optical lens arrangement having a focal length and providing a rear focal plane;
a solid-state sensing array positioned at the rear focal plane of the optical lens arrangement, the solid-state sensing array comprising at least a first sensor and a second sensor configured to detect the reflected laser beam, wherein the first sensor and the second sensor are spaced from each other by a first sensor distance; and
at least one processor configured to:
obtain a measured distance of the target from a pulsed time-of-flight measurement utilizing the laser generator and at least one of the first sensor or the second sensor of the solid-state sensing array; and
obtain at least one spatial coordinate for the target from the measured distance using a calibration parameter indicative of a ratio of the first sensor distance and the focal length.

29. The method according to claim 28, wherein the target comprises a flat surface facing the laser generator, and wherein the laser beam is reflected at the flat surface.

30. The method according to claim 28, wherein the scanning is performed with a major surface of the solid-state sensing array being positioned non-parallel with respect to the target.

31. A method, comprising:
generating, by a laser generator, a pulsed laser beam directed on a target;
collecting, by the an optical lens arrangement, the laser beam after it is reflected by the target to form a reflected laser beam, the optical lens arrangement having a focal length and providing a rear focal plane; and
detecting the laser beam using a solid-state sensing array positioned at the rear focal plane of the optical lens arrangement, wherein the solid-state sensing array comprises at least two sensors which are spaced a first sensor distance apart from each other equidistantly in at least one dimension;
obtaining a measured distance of the target from a pulsed time-of-flight measurement utilizing the laser generator and a sensor of the at least two sensors of the solid-state sensing array; and
obtaining at least one spatial coordinate for the target from the measured distance using a calibration parameter indicative of a ratio of the first sensor distance and the focal length.

32. The method according to claim 31, wherein each sensor of the at least two sensors is a single-photon avalanche diodes (SPAD) arranged at a common substrate of the solid-state sensing array.

33. The method according to claim 31, wherein the at least one spatial coordinate is obtained using an optimal value for the calibration parameter, the optimal value being obtained by:
obtaining multiple measured distances to different spatial locations of the target, each measured distance corresponding to a different sensor of the solid-state sensing array; and
calculating the optimal value by fitting a fitting function to a point cloud function comprising provisional spatial coordinates for the different spatial locations of the target, wherein the provisional spatial coordinates are obtained from the multiple measured distances using a provisional value for the calibration parameter, and the optimal value is the provisional value which optimizes the fitting.

34. The method according to claim 33, wherein the fitting function is a linear function representable as a straight line or a flat plane.

35. The method according to claim 34, wherein the at least one spatial coordinate for the target is obtained from the measured distance by modifying the measured distance by at least one additional sensor-specific calibration parameter indicative of inaccuracy for the measured distance for at least one sensor of the solid-state sensing array.

36. The method according to claim 31, wherein the at least one spatial coordinate for the target is obtained from the measured distance by modifying the measured distance by at least one additional sensor-specific calibration parameter indicative of inaccuracy for the measured distance for at least one sensor of the solid-state sensing array.
